(19) United States
(12) Patent Application Publication
(10) Pub. No.: US 2008/0083333 A1
(43) Pub. Date: Apr. 10, 2008

(54) Dust collector

(75) Inventors: Yasuna Yokoi, Kanie (JP); Toshiaki Kato, Kanie (JP); Masafumi Takeda, Nagoya (JP); Yoshinobu Ito, Komono (JP)

Correspondence Address: QUINN EMANUEL;KODA & ANDROLIA, 865 S. FIGUEROA STREET, 10TH FLOOR, LOS ANGELES, CA, 90017, US

(73) Assignee: ANLET CO., LTD.

(21) Appl. No.: 11/646,676

(22) Filed: Dec. 28, 2006

(30) Foreign Application Priority Data
Oct. 4, 2006 (JP) 2006-272909
Oct. 24, 2006 (JP) 2006-288510

(51) Int. Cl. B01D 46/00

(52) U.S. Cl. 95/277; 55/385.2; 55/356; 55/400; 95/279; 55/302; 55/290

(57) ABSTRACT

A dust collector includes a collection unit including a suction pipe and a Roots blower outwardly discharging the air having passed through the collection unit. The collection unit further includes a rotational shaft rotatably mounted in a housing of the case and disposed so as to face an interior of the case, a rotary filter mounted on the shaft and including a cylindrical porous core and a filter material attached to an outer circumference of the core and having a number of folds made of nonwoven cloth with a mesh into a continuous zigzag shape, an air blower nozzle blowing on an outer surface of the rotary filter pressure air produced by drive of the blower in a reverse direction thereby to clean the filter, and a recovery bag accommodating the dust or the like removed from the rotary filer during cleaning by the air blower nozzle.

### CROSS-REFERENCE TO RELATED APPLICATIONS

This application is based upon and claims the benefit of priority from the prior Japanese Patent Application Nos. 2006-272909 filed on Oct. 4, 2006 and 2006-288510 filed on Oct. 24, 2006, the entire contents of both of which are incorporated herein by reference.

### BACKGROUND OF THE INVENTION

1. Field of the Invention

The present invention relates to a dust collector suitable for collecting or recovering fume produced during arc-welding, minute dust and/or mist produced by cutting machines, grinding machines or the like, carbon, oil component, clouds of dust or the like produced by road sweeping by a unimog and minute dust produced in the process of manufacturing foodstuff such as wheat flour, non-viscous light dust or the like resulting from machining of plastics, paper or wood.

2. Description of the Related Art

Arc-welding of welding iron material to which rustproof oil or paint is applied produces minute fume of 100 angstrom class or minute viscous fume ranging from 0.01 μm to 1.00 μm. General filter dust collectors use filters with mesh ranging from 0.1 μm to 0.5 μm but are susceptible to clogging. In view of the circumstances, a fume recovery method has been developed. In this method, pressure air produced by a turbo blower or air ejector is mixed with lime powder or the like. A collecting surface of the filter is blast with the mixture so that oil content of the fume adherent to the collecting surface is adsorbed. As a result, the filter is cleaned. In another employed method, the filter is vibrated by a vibrator so that fume is removed from the collecting surface. However, the problem of clogging cannot be overcome by these methods completely.

Japanese Patent No. 3316476 to the assignee of this application discloses a filter cleaning apparatus comprising a Roots blower which is reverse rotated so that pressure air is blown off against the backside of the collecting surface of the filter while a rotary nozzle disposed inside the filter is rotated, whereby the filter is cleaned. However, the conventional filter dust collector cannot overcome clogging due to fume containing oil component or viscous fume and cannot maintain a desirable collecting performance.

Conventional dust collectors for collecting mist or the like include those of filter type, demister type, cyclone type, impinging type and electric dust collection type. For example, JP-A-H11-179122 discloses an oil mist collector comprising a suction part which sucks a gas polluted by oil mist, a capturing part which includes a porous filter capturing oil mist from the gas sucked by the suction part, an oil storage part which stores oil mist aggregate captured by the capturing part, and a discharge part which discharges the gas from which oil mist has been removed.

JP-A-2000-296305 discloses a mist recovery apparatus comprising a filtering member provided in an entrance of a hood disposed above a mist producing part. A suction apparatus connected to a suction pipe of the hood is operated so that mist is caused to adhere to the filtering member, whereupon resultant liquefaction product is absorbed thereby to be recovered.

JP-A-H09-47617 discloses a mist remover comprising a collecting chamber provided with a colleting plate having a porous material layer formed on a surface with which mist collides. Air containing mist is introduced into the collecting chamber to be caused to collide with the collecting plate, thereby being collected.

Japanese Patent No. 2881684 discloses a method of cooling and purifying waste combustion gas and a device therefor. Waste gas is caused to come into contact with circulating water in a closed chamber in a path through which high temperature exhaust gas is discharged into external air. The temperature of the exhaust gas is decreased by resultant heat of evaporation, whereby solid particle such as carbon powder in exhaust gas and hazardous component such as carbon monoxide are decomposed thereby to be adsorbed to water.

There are various aspects of mist such as water mist, oil mist or the like as Japanese Patent No. 2881684 describes. Furthermore, there is coarse mist with particle size of about 20 μm or above and fine mist with particle size of about 1 to 0.01 μm or below. Accordingly, above-described collecting methods are employed according to aspects of mist. When any method is employed, it would be difficult to achieve amenity in working environment, safety in workers' health or normal operation of processing machinery and equipment which produce mist, or to prevent contamination of circumjacent buildings, unless produced mist is efficiently treated.

On the other hand, fine dust is produced in the process of manufacturing food such as wheat flour. Furthermore, non-viscous light dust is produced in the process of plastics, paper or wood. The fine dust and non-viscous light dust are collected by a dust collector.

JP-A-H11-333232 discloses a dust collector comprising a suction drive which sucks dust by suction force of a motor-driven fan, a silencer which is coupled vertically to the suction drive, a cyclone separator which includes an upper bag attached to an upper part located in the direction perpendicular to the silencer and a dust bag attached to a part located below the upper part, a base to which the suction drive is fixed and a bag mounting on which the dust bag is placed. The disclosed dust collector is convenient since the dust bag can be carried on the bag mounting. However, the dust collector is constructed so that the upper bag is disposed above the dust bag, whereupon the height of the dust collector is increased. As a result, the dust collector sometimes has a definite limitation in the service space.

JP-A-2002-282633 discloses a multistage dust collector comprising two chambers obtained by partitioning the interior of a body thereof by a middle partition wall, the chambers serving as a dust chamber provided with an inlet port for a dust containing airflow and as a clean chamber provided with an outlet port for clean air. A plurality of filter units are mounted on the middle partition wall in a vertical multistage disposition. Each filter unit has an inlet side facing the dust chamber and an outlet side facing the clean chamber. This dust collector prevents dust in cleaning one filter from re-adhering to another filter. However, since a plurality of filter units are used in the dust collector, replacement costs of the filter units are increased.

### SUMMARY OF THE INVENTION

Therefore, an object of the present invention is to provide a small high-performance dust collector which is suitable for collection of fume produced during arc-welding, minute dust and/or mist produced by cutting machines, grinding machines or the like, minute dust produced in the process of manufacturing foodstuff such as wheat flour, non-viscous light dust or the like resulting from machining of plastics, paper or wood.

The present invention provides a dust collector comprising a collection unit including a suction pipe sucking in fume, mist, dust or the like resulting from welding together with ambient air, there by collecting the mist, dust or the like, the collecting unit further including a case having a housing, and a Roots blower rendering an atmospheric pressure in the case negative and outwardly discharging the air having passed through the collection unit, the blower driven in normal and reverse directions. The collection unit further includes a rotational shaft rotatably mounted in the housing and disposed so as to face an interior of the case, the rotational shaft having a distal end, a rotary filter mounted on the distal end of the rotational shaft and including a cylindrical porous core and a filter material attached to an outer circumference of the core and having a number of folds made of nonwoven cloth with a mesh ranging from 0.3 μm to 1.0 μm into a continuous zigzag shape, an electric motor capable of rotating the rotary filter at a predetermined speed, an air blower nozzle blowing on an outer circumferential surface of the rotary filter pressure air produced by drive of the blower in the reverse direction, thereby cleaning the filter, and a recovery bag accommodating the dust or the like removed from the rotary filer during cleaning by the air blower nozzle, the recovery bag being detachably attached a lower part of the case.

As the result of a compact combination of the collection unit using the rotary filter and the Roots blower, the above-described construction can efficiently collect and recover viscous fume produced rustproof oil or paint applied to iron material to be welded in an arc-welding work, minute dust and/or mist produced by cutting machines, grinding machines or the like. Furthermore, since pressure air is blown against the rotary filter by the air blow nozzle so that dust and/or the like adherent to the filter is removed, the filter can be maintained in a desired state.

In another form, the dust collector further comprises a recovery tank detachably attached to the lower part of the case, instead of the recovery bag. Since the collected dust is stored in the recovery tank, the post treatment of dust can easily be carried out.

In further another form, the dust collector further comprises a detachable tank provided between the suction pipe and the collection unit, the detachable tank incorporated with a cyclone which is formed into a shape flaring out at a bottom thereof. This dust collector has such a construction as to be capable of collecting, in the detachable tank, carbon, oil component, clouds of dust or the like produced by road sweeping by a unimog. Since this construction suppresses flow of dust or the like into the collection unit, the filter can be prevented from clogging.

The invention also provides a dust collector comprising a collection unit including a suction pipe sucking in non-viscous light dust or the like together with ambient air, thereby collecting the dust or the like, the collecting unit further including a case having a housing, and a Roots blower rendering an atmospheric pressure in the case negative and outwardly discharging the air having passed through the collection unit, the blower driven in normal and reverse directions. The collection unit further includes a rotational shaft rotatably mounted in the housing and disposed so as to face an interior of the case, the rotational shaft having a distal end, a rotary filter mounted on the distal end of the rotational shaft and including a cylindrical porous core and a filter material attached to an outer circumference of the core and having a number of folds made of nonwoven cloth with a mesh ranging from 0.3 μm to 10.0 μm into a continuous zigzag shape, an electric motor capable of rotating the rotary filter at a predetermined speed, an air blower nozzle blowing on an outer circumferential surface of the rotary filter pressure air produced by drive of the blower in the reverse direction, thereby cleaning the filter, and a recovery tank or bag accommodating the dust or the like removed from the rotary filer during cleaning by the air blower nozzle while the air having passed through the rotary filter is discharged outward through a silencer, the recovery bag being detachably attached a lower part of the case.

As the result of a compact combination of the collection unit using the rotary filter and the Roots blower, the above-described construction can collect non-viscous light fume at a high efficiency of about 99% without a large installation space. Furthermore, since pressure air is blown against the rotary filter by the air blow nozzle so that dust and/or the like adherent to the filter is removed, the filter can be maintained in a desired state.

The aforesaid the light dust or the like includes minute dust of food material or dust resulting from processing of plastic, paper or wood. Thus, the dust collector is suitable for collection of minute dust produced in the process of manufacturing foodstuff such as wheat flour, non-viscous light dust or the like resulting from machining of plastics, paper or wood.

### BRIEF DESCRIPTION OF THE DRAWINGS

Other objects, features and advantages of the present invention will become clear upon reviewing the following description of the preferred embodiments with reference to the accompanying drawings, in which:

FIG. 1 schematically illustrates a dust collector of a first embodiment in accordance with the present invention;

FIG. 2 is a longitudinally sectional side view of a collection unit of the dust collector;

FIG. 3 is a longitudinally sectional front view of a rotary filter of the dust collector;

FIG. 4 illustrates a convex part of the rotary filter;

FIG. 5 schematically illustrates a grinding machine to which the dust collector of the first embodiment is applied;

FIG. 6 schematically illustrates the dust collector of the first embodiment applied to road sweeping by a unimog;

FIG. 7 schematically illustrates a detachable tank of the dust collector;

FIG. 8 is a graph showing experimental results regarding the relationship between the collecting performance and pressure loss in the duct collector;

FIG. 9 is a graph showing experimental results regarding the relationship between the collecting performance and pressure loss in dust collectors of comparative examples 1 to 3;

FIG. 10 is a view similar to FIG. 1, showing a dust collector of a second embodiment in accordance with the present invention;

FIG. 11 is a longitudinally sectional side view of a collection unit of the dust collector;

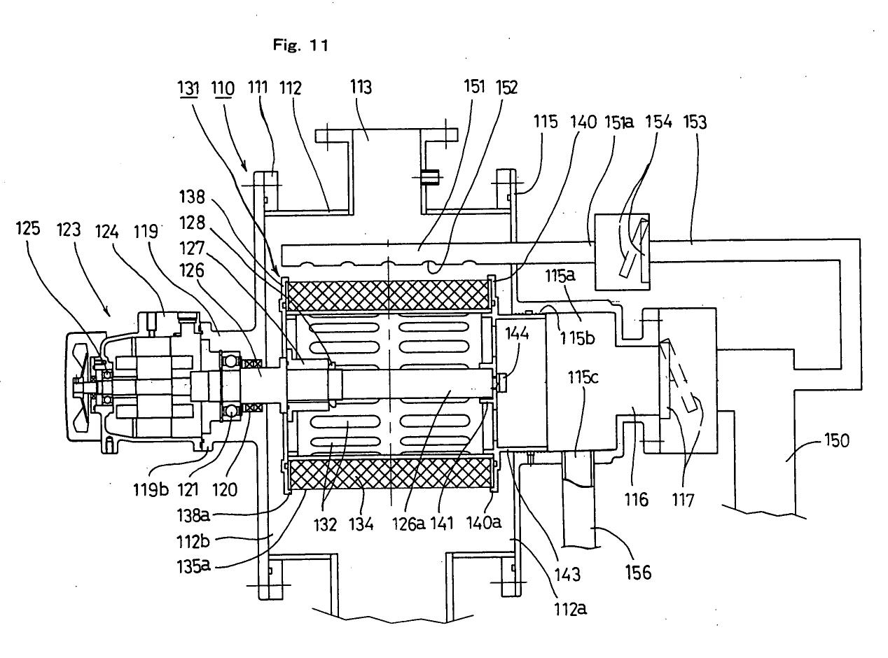

FIG. 12 is a longitudinally sectional front view of the collection unit;

FIG. 13 schematically illustrates an experimental apparatus; and

FIG. 14 is a graph showing experimental results regarding the relationship between the collecting performance and pressure loss in the dust collector of the second embodiment.

### DETAILED DESCRIPTION OF THE INVENTION

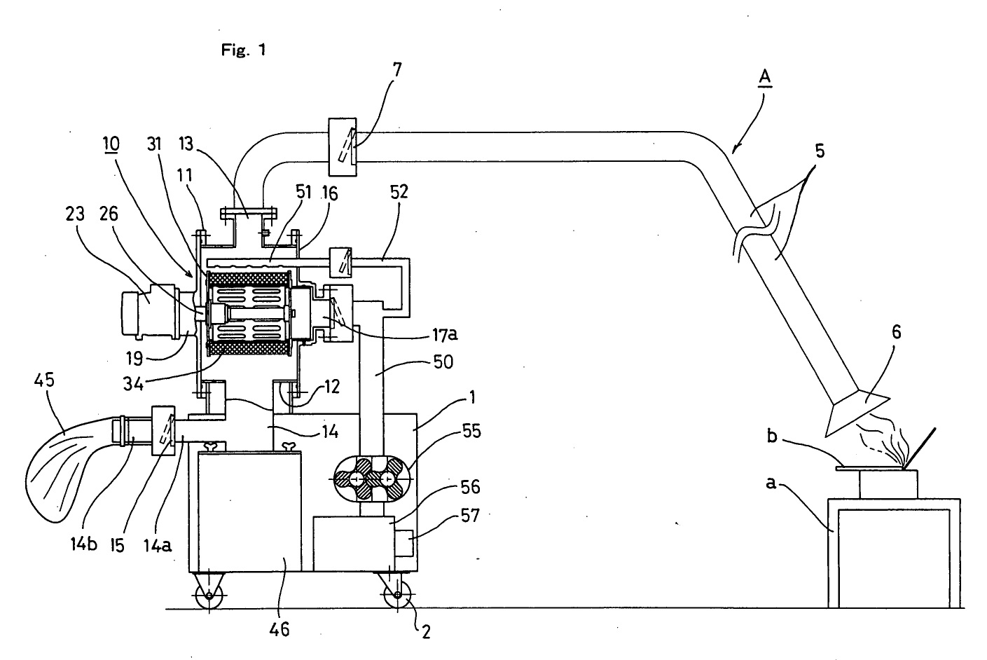

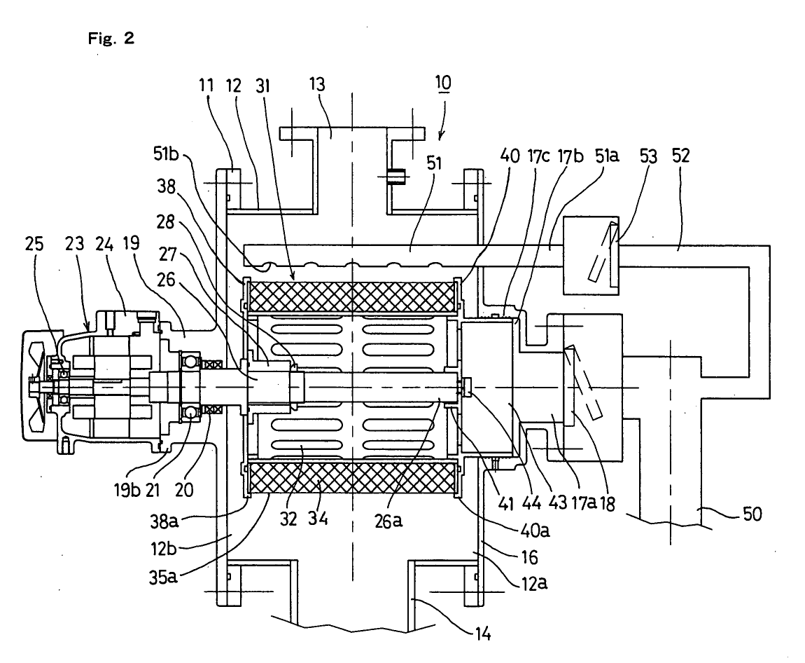

A first embodiment of the present invention will be described with reference to FIGS. 1 to 7. Referring to FIG. 1, a dust collector A of the first embodiment is shown. The dust collector A comprises a collection unit 10 and a Roots blower 55. The collection unit 10 includes a suction pipe 5 having a distal end on which a suction hood 6 is mounted. Through the suction hood 6 is sucked viscous fume resulting from welding, mist or dust produced by a grinding machine or the like together with ambient air. The viscous fume, mist or dust sucked from the food 6 is collected by the collection unit 10. The collection unit 10 includes a case 11 in which negative pressure is developed by the Roots blower 55. Air having passed through the collection unit 10 is discharged out by the Roots blower 55. The collection unit 10 and the Roots blower 55 are installed on a frame 1 provided with canisters 2. A check valve 7 is provided on the suction pipe 5.

The case 11 of the collection unit 10 comprises a cylindrical case body 12, an end cover 16 and a housing 19. The end cover 16 is formed with an outlet 17a in which another check valve 18 is provided. The end cover 16 is mounted on one open end 12a of the case body 12. The housing 19 is mounted on the other open end 12b of the case body 12. The case body 12 includes a barrel part formed with an inlet 13 to which the suction pipe 5 is connected and a fume discharge pipe 14. The housing 19 has a central hole in which an annular seal 20 and a ball bearing 21 are provided. A rotational shaft 26 of an electric motor 23 is inserted through the ball bearing 21 and the seal 20 as will be described later. The motor 23 includes a casing 24 mounted to a small-diameter flange 19b of the housing 19. The rotational shaft 26 of the motor 23 is rotatably supported on the ball bearing 21 and a ball bearing 25 incorporated in the casing 24. The motor shaft 26 has a distal end 26a which is disposed so as to face the interior of the case 11.

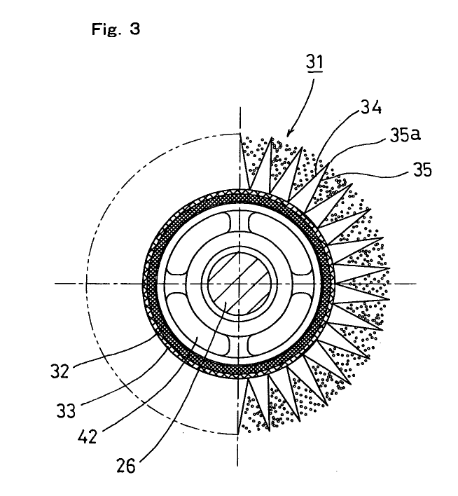

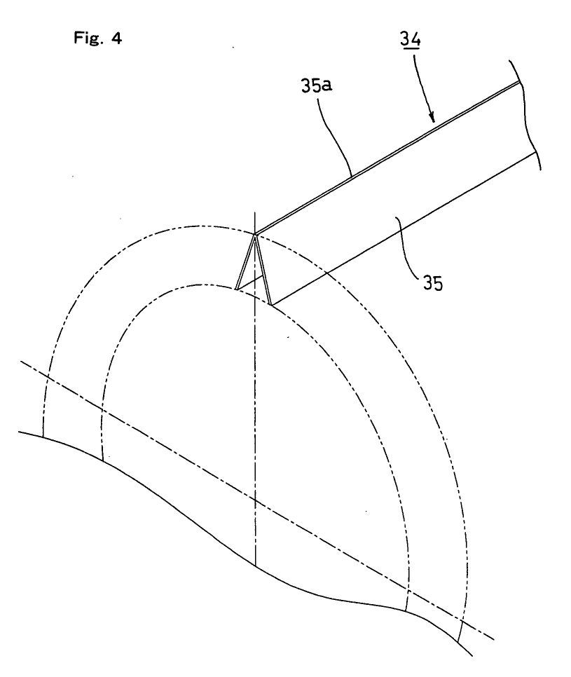

A rotary filter 31 is detachably attached to the distal end 26a of the rotational shaft 26 as shown in FIG. 3. The rotary filter 31 comprises a cylindrical porous core 32 such as a punching metal and a coarse soft interfering material 33, such as an oil-resistant polypropylene, adherent to an outer circumference of the core 32 and a cylindrical filter material 34 attached to an interfering material 33. Both ends of the core 32, interfering material 33 and filter material 34 are held between two face plates 38 and 40. The core 32, interfering material 33 and filter material 34 are then fixed to the rotational shaft 26. The filter material 34 is capable of collecting minute fume with a particle diameter in the order of 100 angstroms and has a number of zigzag continuous folds 35 made of a nonwoven cloth having a mesh ranging from 0.3 μm to 1.0 μm as shown in FIGS. 3 and 4. The filter 34 has an outer diameter ranging from 200 to 500 mm and a length ranging from 200 to 500 mm.

The face plate 38 has a centrally formed through hole through which the rotational shaft 26 is loosely inserted. A bush 27 is then fitted with the shaft 26. In this state, a nut 28 threadingly engaged with the shaft 26 is tightened up so that the face plate 38 is fixed to the shaft 26. The face plate 38 has an inwardly oriented flange 38a formed on the outer periphery thereof. Each convex part of the filter material 34 is loosely fitted with the flange 38a.

On the other hand, the face plate 40 has a shaft cylinder 41 formed on the central inner wall thereof and a central through hole (not shown). The shaft is inserted into the shaft cylinder 41 and a bolt 44 is inserted through the hole to be tightened up so that the face plate 40 is fixed to the shaft 26. The shaft cylinder 41 has four holes 42 formed circumferentially. The face plate 40 has an inwardly oriented flange 40a formed on the outer circumference thereof. Each convex part 35a of the filter material 34 is loosely fitted with the flange 40a. The faceplate 40 further has a cylindrical part 43 formed on an outer central part thereof. The cylindrical part 43 is inserted into a large diameter hole 17b of the end cover 16 so as to be substantially in contact with the hole 17b. The large diameter hole 17b has a plurality of annular grooves 17c which form labyrinth seal together with the cylindrical part 43.

The rotary filter 31 is driven at 500 to 1,000 rpm by the motor 23. A branch pipe 14a diverted from the fume discharge pipe 14 has an exit 14b to which a recovery bag 45 is detachably attached to the exit 14b. Part of dust removed from the rotary filter 31 is recovered by the recovery bag 45. A check valve 15 is provided on the branch pipe 14a. A generally box-shaped recovery tank 46 is attachable to the fume discharge pipe 14. The collection unit 10 includes an outlet 17a to which a suction side of the Roots blower 55 is connected via a suction pipe 50.

An air blow nozzle 51 is provided for cleaning the rotary filter 31. The air blow nozzle 51 includes several outlets 51b oriented toward an outer circumferential surface of the rotary filter 31. The air blow nozzle 51 is connected via the supply pipe 52 to the suction pipe 50. A check valve 53 is provided on the supply pipe 52. The Roots blower 55 is of a three-lobed type and is switchable between a normal rotation and reverse rotation. An exhaust tank 56 is coupled to the exhaust side of the Roots blower 55. The exhaust tank 56 is provided with an exhaust outlet 57.

The dust collector A will operate as follows when used for collection of fume resulting from arc-welding. Weld iron material b is placed on a mount a and rust preventing oil and paint are applied to the iron material b. When arc welding is carried out for the iron material b, fume dust with a particle diameter in the order of 100 angstroms is produced together with viscous fume. In the duct collector A, the collection unit 10 and the suction pipe 5 are maintained in the negative pressure. The negative pressure action causes fume produced as described above to flow through the suction hood 6 and the suction pipe 5 into the collection unit 10 with ambient air.

In the collection unit 10, the motor 23 is controlled so that rotary filter 31 is rotated in the range from 500 to 1000 rpm. Accordingly, viscous fume contained in the air sucked into the case 11 is sputtered by the centrifugal action of the rotary filter 31 thereby to be separated. The fume separated by the rotary filter 31 falls down into a lower interior of the case 11, accumulating in the recovery tank 46. Air dried by the collection unit 10 is discharged outward through the suction pipe 50 and the Roots blower 55 from the exhaust outlet 57 of the exhaust tank 56.

Furthermore, when the Roots blower 55 is switched from the normal rotation to the reverse rotation, air is drawn from the exhaust side of the blower 55. The drawn air the pressure of which is increased is introduced through the supply pipe 52 into the air blow nozzle 51. The rotary filter 31 is cleaned by pressure air blown out of the air blow nozzle 51, whereupon the fume having been removed by the filter 31 falls into the downwardly located fume discharge pipe 14, accumulating in the recovery bag 45 and the recovery tank 46. The filter 31 is preferably rotated at about 100 rpm when cleaned.

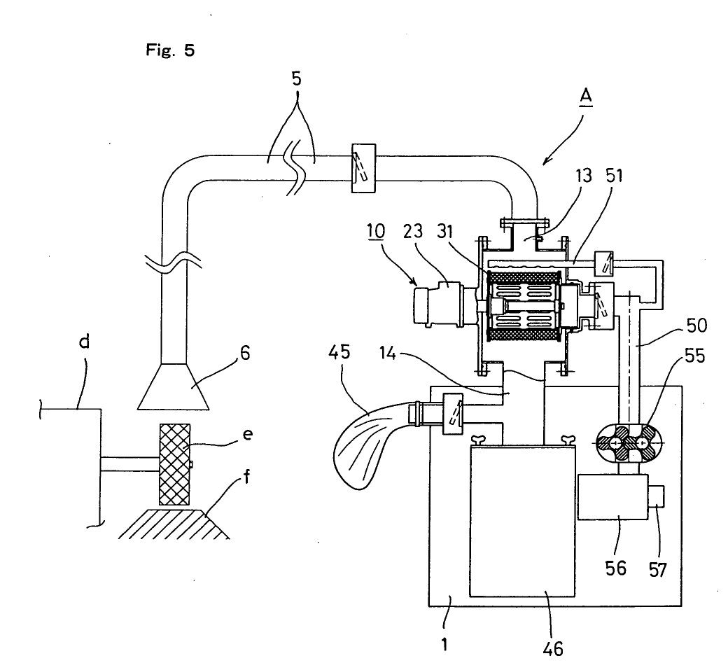

The dust collector A of the first embodiment can be applied to collection of minute dust and mist produced by a grinding machine d as shown in FIG. 5. In the figure, reference symbol e designates a disc-shaped grind stone which is rotatably provided on the grinding machine d. Reference symbol f designates a workpiece to be processed.

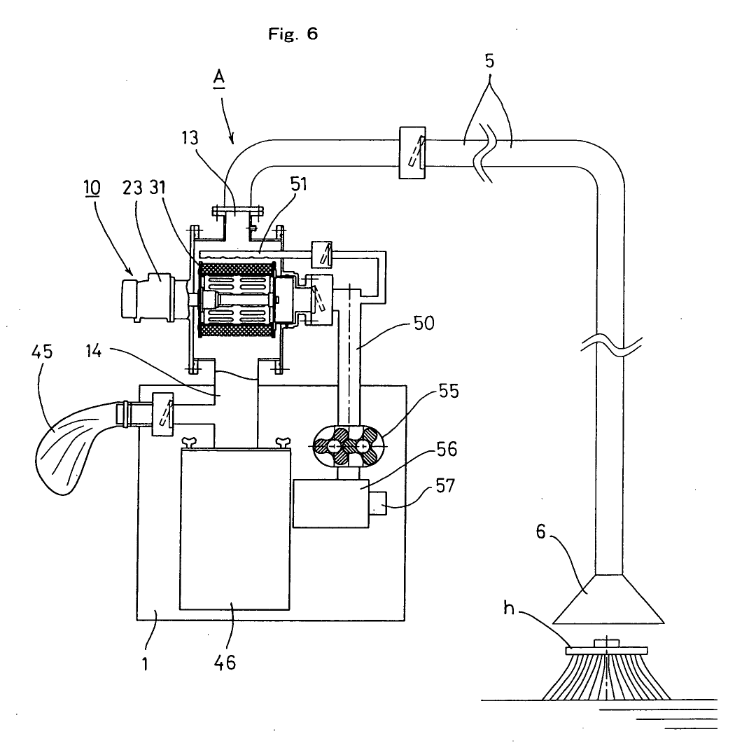

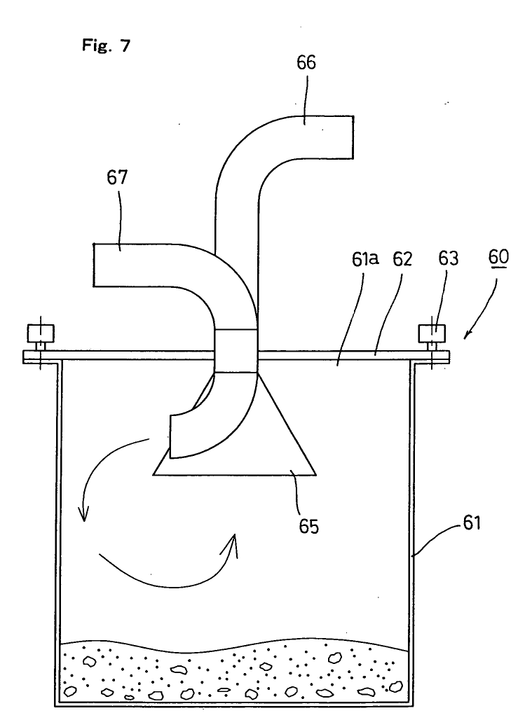

Furthermore, the dust collector A of the first embodiment can be applied to collection of carbon, oil component, clouds of dust or the like produced by road sweeping by a unimog as shown in FIG. 6. In the figure, reference symbol h designates a rotary brush mounted on the unimog (not shown). When there is a possibility that a large amount of dust may be contained during road sweeping, the dust would be sucked into the collection unit 10 such that the rotary filter 31 would be clogged. In view of the drawback, it is preferable to interpose a separation tank 60 between the suction pipe 5 of the dust collector A and the collection unit 10 as shown in FIG. 7. The separation tank 60 includes a lid 62 detachably mounted on the top of the tank body 61 so that an upper opening 61a is closed. The lid 62 is fixed to the tank body 61 by bolts 63. The lid 62 includes a cyclone 65 which is formed in the central part thereof so as to flare out toward the bottom of the tank body 61. The separation tank 60 further includes an inlet pipe 67 connected to the suction pipe 5. The cyclone 65 includes an outlet pipe 66 connected to the inlet 13 of the collection unit 10.

### Experiment 1

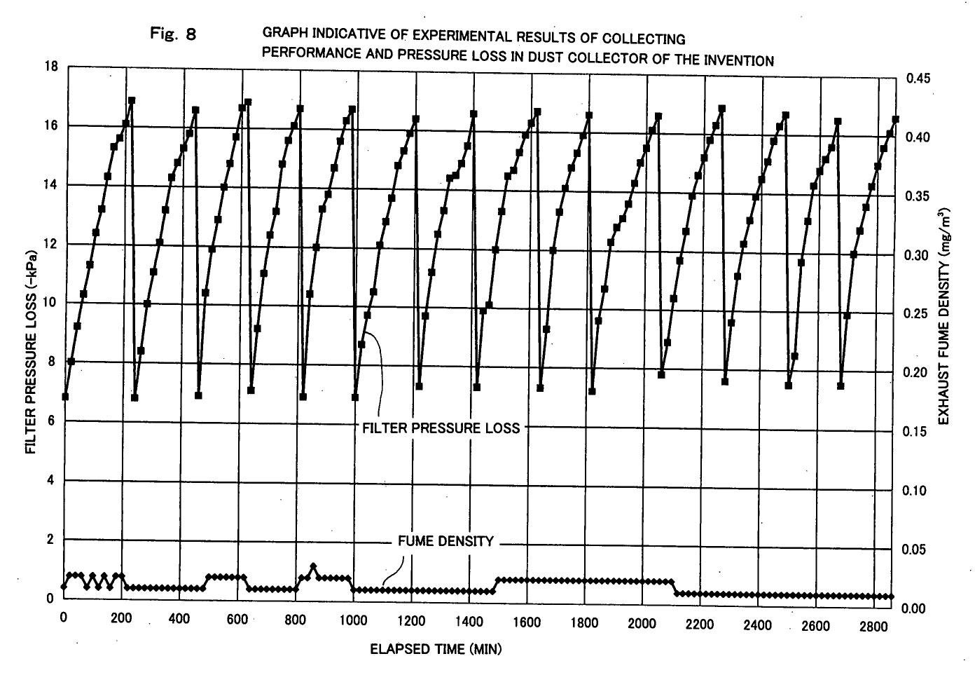

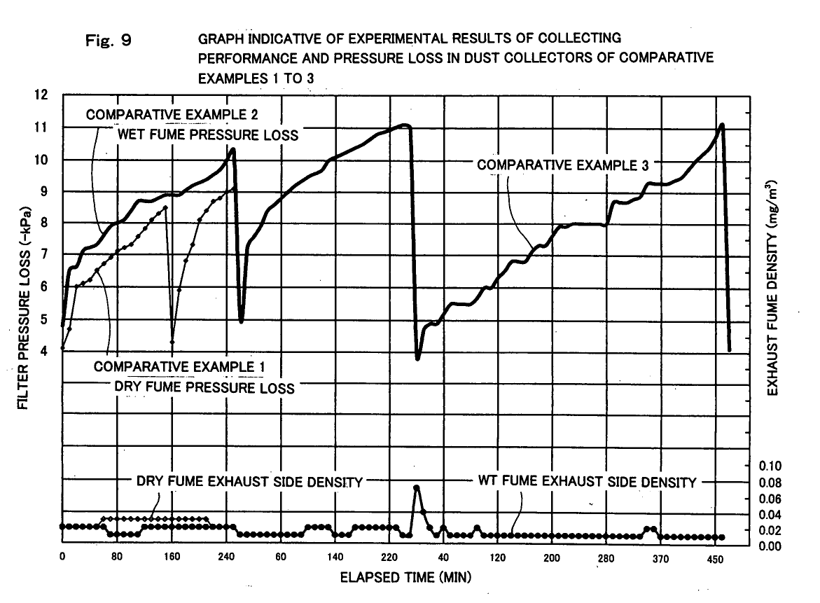

Experiment 1 was conducted under the following conditions regarding the performance of collecting viscous fume (wet fume) produced during welding of a weld iron material to which rustproof oil or paint has been applied and pressure loss between the suction hood and the suction opening of the Roots blower. Comparative examples 1 to 3 were involved in the experiment. FIGS. 8 and 9 are graphs showing the results of the experiment. TABLE A describes the dust collector A used in the experiment 1.

TABLE 1
Dust collector A

| Collection unit | |
|---|---|
| Filter: | Synthetic non-woven cloth was used as |
| | filter material. 0.3-μm mesh, |
| | diameter of 200 mm × length of 200 mm |
| Rotational speed | 1000 rpm |
| of filter: | |
| Motor output: | 0.4 kw |
| Roots blower: | Bore diameter of 50 mm × output of 1.5 kw, |
| | rotational speed of 2500 rpm |
| | air discharge rate of 1.5 m³/min |
| Amount of produced wet | About 20 mg/m³ |
| fume: | |

In the embodiment, the filter was cleaned repeatedly by an air blow nozzle using wet fume.

FIG. 8 shows results of the experiment regarding the embodiment. Pressure loss of the filter was −17 kPa after operation for 200 minutes and no large pressure fluctuation occurred in the operation for 2800 minutes. The fume density measured at the discharge side of the Roots blower underwent a transition in a range of at or below about 0.02 mg/m³. Thus, the experiment confirmed that a desired collecting effect could be achieved from the dust collector of the embodiment.

Comparative example 1 was experimented in relation to dry fume produced during welding of weld iron material to which no rustproof oil was applied. Air blow was carried out inside the filter so that the filter was cleaned. FIG. 9 shows results of the experiment regarding comparative example 1. Pressure loss of the filter was −8.5 kPa after operation for 160 minutes and the fume density measured was 0.025 mg/m³.

Comparative example 2 was experimented in relation to wet fume. Air blow was carried out inside the filter so that the filter was cleaned. Amount of produced wet fume was about 10 mg/m³. FIG. 9 also shows results of the experiment regarding comparative example 2. Pressure loss of the filter was −10.5 kPa after operation for 240 minutes.

Comparative example 3 was experimented in relation to wet fume. Air blow was carried out outside the filter so that the filter was cleaned. The used filter material was provided with slits formed in the convex portions 35a of the folds 35 of the filter material 34 as employed in the embodiment. The slits each of which has the length of 30 mm were formed at intervals of 20 mm. FIG. 9 further shows results of the experiment regarding comparative example 3. The pressure loss of the filter was −11 kPa. It is considered that the slits of the filter material causes microvibration of the folds 35 which reduces clogging of the filter material.

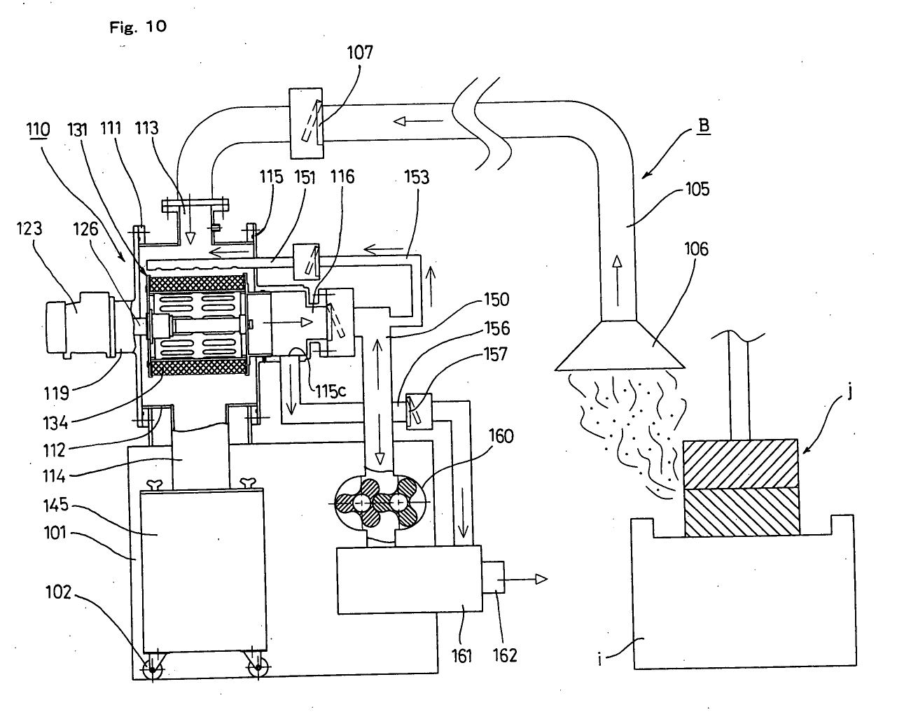

FIG. 10 illustrates a second embodiment of the invention. The dust collector B of the second embodiment has the same primary construction as the dust collector A of the first embodiment.

The dust collector B comprises a collection unit 110 and a Roots blower 160. The collection unit 110 includes a suction pipe 105 having a distal end on which a suction hood 106 is mounted. Through the suction hood 106 is sucked minute dust produced in the process of manufacturing foodstuff such as wheat flour, non-viscous light dust or the like resulting from machining of plastics, paper or wood together with air. The non-viscous fume or dust sucked from the hood 106 is collected by the collection unit 110. The collection unit 10 includes a case 111 in which negative pressure is developed by the Roots blower 160. Air having passed through the collection unit 110 is discharged out by the Roots blower 160. The collection unit 110 and the Roots blower 160 are installed on a frame 101 provided with canisters 102. A check valve 107 is provided on the suction pipe 105.

The case 111 of the collection unit 110 comprises a cylindrical case body 112, an end cover 115 and a housing 119. The end cover 115 is formed with an outlet 116 in which another check valve 117 is provided. The end cover 115 is mounted on one open end 112a of the case body 112. The housing 119 is mounted on the other open end 112b of the case body 112. The case body 112 includes a barrel part formed with an inlet 113 to which the suction pipe 105 is connected and a fume discharge pipe 114.

The housing 119 has a central hole in which an annular seal 120 and a ball bearing 121 are provided. A rotational shaft 126 of an electric motor 123 is inserted through the ball bearing 121 and the seal 120 as will be described later. The motor 123 includes a casing 124 mounted to a small-diameter flange 119b of the housing 119. The rotational shaft 126 of the motor 123 is rotatably supported on the ball bearing 121 and a ball bearing 125 incorporated in the casing 124. The motor shaft 126 has a distal end 126a which is disposed so as to face the interior of the case 111.

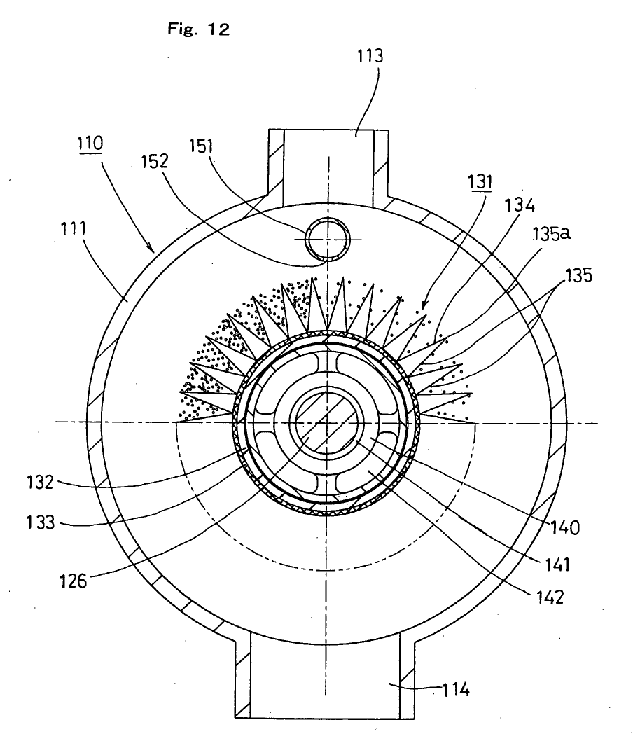

A rotary filter 131 is detachably attached to the rotational shaft 26. The rotary filter 131 comprises a cylindrical porous core 132 such as a punching metal and a coarse soft interfering material 133, such as an oil-resistant polypropylene, adherent to an outer circumference of the core 132 and a cylindrical filter material 134 attached to an interfering material 133, as shown in FIG. 12. Both ends of the core 132, interfering material 133 and filter material 134 are held between two face plates 138 and 140. The core 132, interfering material 133 and filter material 134 are then fixed to the rotational shaft 126. The structure for fixing the filter material 134 to the rotational shaft 126 is the same as that described in the first embodiment and accordingly, the description of the structure will be eliminated.

The filter material 134 is capable of collecting minute dust produced in the process of manufacturing foodstuff such as wheat flour, non-viscous light dust or the like resulting from machining of plastics, paper or wood. The filter material 134 has a number of zigzag continuous folds 35 made of a nonwoven cloth having a mesh ranging from 0.3 μm to 10 μm. The filter 134 has an outer diameter ranging from 200 to 500 mm and a length ranging from 200 to 500 mm.

The face plate 140 further has a cylindrical part 143 formed on an outer central part thereof. The cylindrical part 143 is inserted into a large diameter hole 115a of the end cover 115 so as to be substantially in contact with the hole 115a. The large diameter hole 115a has a plurality of annular grooves 115b which form labyrinth seal together with the cylindrical part 143. Reference symbol 115c designates an exhaust outlet for pressure air provided in the large diameter hole 115a.

The rotary filter 131 is driven at 500 to 3,600 rpm by the motor 123. A generally box-shaped recovery tank 145 (or a recovery bag) is attachable to the fume discharge pipe 114. The recovery tank 145 is provided for recovering dust or the like removed form the rotary filter 131. The Roots blower 160 has the suction side connected via a suction pipe 150 to an outlet 116 of the collection unit 110.

An air blow nozzle 151 is provided for cleaning the rotary filter 131. The air blow nozzle 151 includes several outlets 152 oriented toward an outer circumferential surface of the rotary filter 131. The air blow nozzle 151 has an air inlet 151a connected via a supply pipe 153 to the suction pipe 150. Reference numeral 154 designates a check valve provided on the supply pipe 153. A silencer 161 is coupled to the exhaust side of the Roots blower 160 and has an exhaust outlet 162. An exhaust pipe 156 provided with a check valve 157 is connected between the silencer 161 and the exhaust outlet 115c.

The dust collector B will operate as follows. Non-viscous light dust or the like is produced when wheat flour, plastics, paper, wood or the like is processed on a mount i by a processing machine j. In the duct collector B, the collection unit 110 and the suction pipe 105 are maintained in the negative pressure by the normal rotation of the Roots blower 160. The negative pressure action causes the light dust produced as described above to flow through the suction hood 106 and the suction pipe 105 into the collection unit 105 with ambient air.

In the collection unit 110, the motor 123 is controlled so that rotary filter 131 is rotated in the range from 500 to 3, 600 rpm. Accordingly, light dust contained in the air sucked into the case 111 is sputtered by the centrifugal action of the rotary filter 131 thereby to be separated. The light dust or the like separated by the rotary filter 131 falls down into a lower interior of the case 111, accumulating in the recovery tank 145. Air cleaned by the collection unit 110 is discharged outward through the suction pipe 150 and the Roots blower 160 from the exhaust outlet 162 of the silencer 161.

The cleaning of the rotary filter 131 is the same as that described in the first embodiment and accordingly, the description thereof will be eliminated.

### Experiment 2

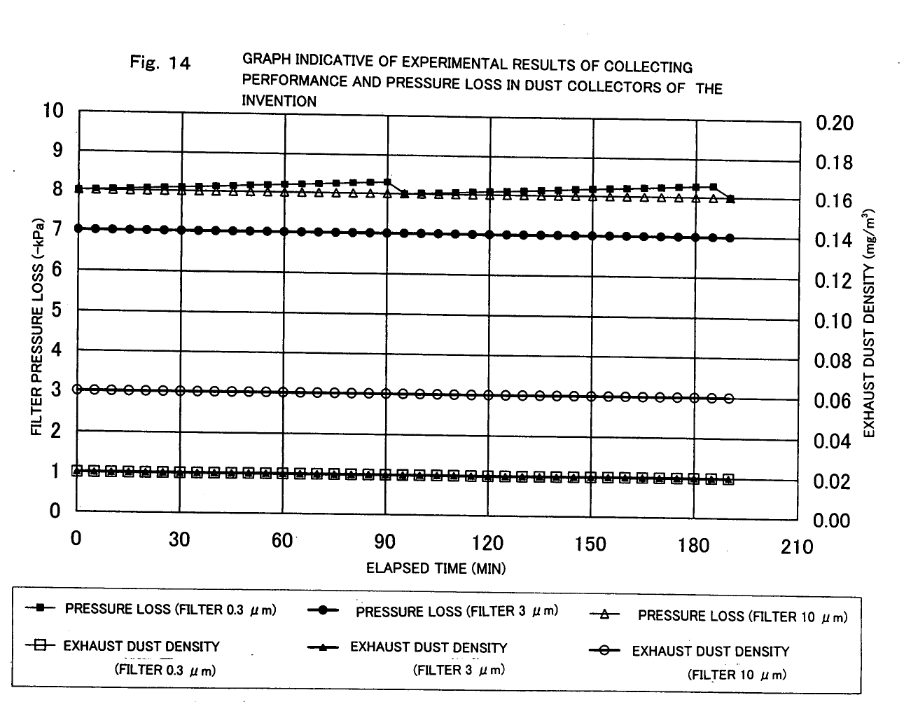

Experiment 2 was conducted under the following conditions regarding the collecting performance of the dust collector B and pressure loss between the suction hood and the suction opening of the Roots blower. Wheat flour was used to resemble dust in experiment 2. More specifically, wheat flour contained in a container was flung up by pressure air used in a factory. FIG. 14 is a graph showing the results of the experiment. TABLE 2 describes the dust collector B used in the experiment.

TABLE 2
Dust collector B

| Collection unit | |
|---|---|
| Filter: | Three types of 0.3-μm mesh, 3-μm mesh and |
| | 10-μm mesh |
| | diameter of 200 mm × length of 200 mm × surface |
| | area of 1.2 m² |
| Rotational speed | 1500 rpm in the suction and 150 rpm in the |
| of filter: | cleaning |
| Motor output: | 0.4 kw |
| Roots blower | Bore diameter of 50 mm × output of 1.5 kw, |
| Rotational speed: | 3000 rpm in the suction and 1800 rpm in |
| | the cleaning |
| Air discharge rate: | 2.2 m³/min in the suction and 1.0 m³/min |
| | in the cleaning |
| Pressure: | −10 kPa in the suction and +30 kPa in the |
| | Cleaning |

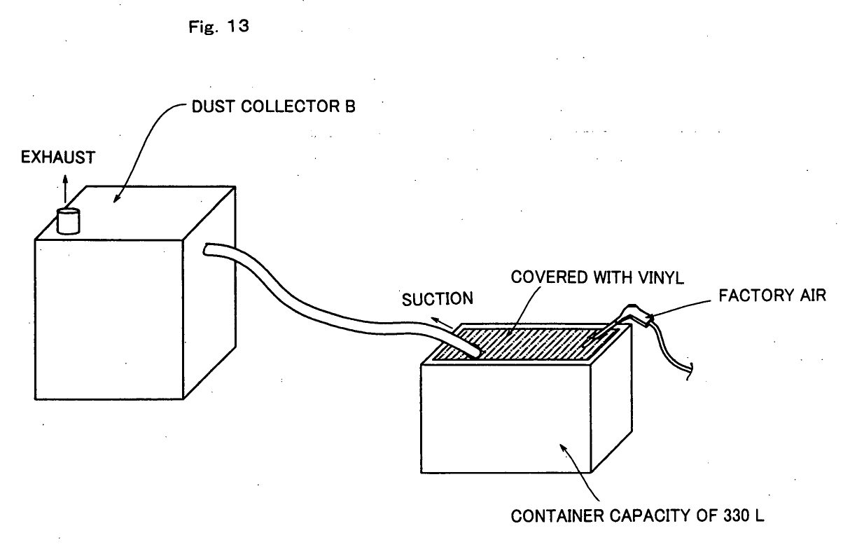

Regarding an experimental apparatus, about 2.5 kg wheat flour contained in a container was flung up by pressure air used in a factory. Thus, the wheat flour used to resemble dust was collected by the dust collector B of the second embodiment (see FIG. 13). The used container had the size of 1×0.65×0.52 m and the capacity of 330 lit. Pressure air was at 200 NL/min and 0.5 Mpa. However, regarding the filter of 0.3-μm mesh, the cleaning work was carried out upon lapse of 90 minutes and 180 minutes.

FIG. 14 shows the experimental results regarding the second embodiment. The pressure loss of the filter after operation for 180 minutes was about −8 kPa in the 0.3-μm mesh and 3-μm mesh, whereas the pressure loss was −7 kPa in the 10-μm mesh. No large pressure fluctuation was found. The fume density measured at the discharge side of the Roots blower underwent a transition in a range of at about 0.02 mg/m³ in the 0.3-μm mesh and 3-μm mesh and about 0.06 mg/m³ in the 10-μm mesh. The 3-μm mesh filter had better results in the experiment.

Furthermore, the filter with the 0.3-to-3.0-μm mesh was found to be suitable for collection of minute dust with a particle diameter of about 1 μm to dust with a particle diameter of 100 μm. Additionally, the filter with the 0.3-to-3.0-μm mesh was also found to be suitable for collection of dust resulting from processing of plastics or wood.

The foregoing description and drawings are merely illustrative of the principles of the invention and are not be construed in a limiting sense. Various changes and modifications will become apparent to those of ordinary skill in the art. All such changes and modifications are seen to fall within the scope of the invention as defined by the appended claims.

What is claimed is:

1. A dust collector comprising:
a collection unit including a suction pipe sucking in fume, mist, dust or the like resulting from welding together with ambient air, thereby collecting the mist, dust or the like, the collecting unit further including a case having a housing; and
a Roots blower rendering an atmospheric pressure in the case negative and outwardly discharging the air having passed through the collection unit, the blower driven in normal and reverse directions, wherein the collection unit further includes:
a rotational shaft rotatably mounted in the housing and disposed so as to face an interior of the case, the rotational shaft having a distal end;
a rotary filter mounted on the distal end of the rotational shaft and including a cylindrical porous core and a filter material attached to an outer circumference of the core and having a number of folds made of nonwoven cloth with a mesh ranging from 0.3 μm to 1.0 μm into a continuous zigzag shape;
an electric motor capable of rotating the rotary filter at a predetermined speed;
an air blower nozzle blowing on an outer circumferential surface of the rotary filter pressure air produced by drive of the blower in the reverse direction, thereby cleaning the filter; and
a recovery bag accommodating the dust or the like removed from the rotary filer during cleaning by the air blower nozzle, the recovery bag being detachably attached a lower part of the case.

2. The dust collector according to claim 1, further comprising a recovery tank detachably attached to the lower part of the case, instead of the recovery bag.

3. The dust collector according to claim 1, further comprising a detachable tank provided between the suction pipe and the collection unit, the detachable tank incorporated with a cyclone which is formed into a shape flaring out at a bottom thereof.

4. The dust collector according to claim 2, further comprising a detachable tank provided between the suction pipe and the collection unit, the detachable tank incorporated with a cyclone which is formed into a shape flaring out at a bottom thereof.

5. A dust collector comprising:
a collection unit including a suction pipe sucking in non-viscous light dust or the like together with ambient air, thereby collecting the dust or the like, the collecting unit further including a case having a housing; and
a Roots blower rendering an atmospheric pressure in the case negative and outwardly discharging the air having passed through the collection unit, the blower driven in normal and reverse directions, wherein the collection unit further includes:
a rotational shaft rotatably mounted in the housing and disposed so as to face an interior of the case, the rotational shaft having a distal end;
a rotary filter mounted on the distal end of the rotational shaft and including a cylindrical porous core and a filter material attached to an outer circumference of the core and having a number of folds made of nonwoven cloth with a mesh ranging from 0.3 μm to 10.0 μm into a continuous zigzag shape;
an electric motor capable of rotating the rotary filter at a predetermined speed;
an air blower nozzle blowing on an outer circumferential surface of the rotary filter pressure air produced by drive of the blower in the reverse direction, thereby cleaning the filter; and
a recovery tank or bag accommodating the dust or the like removed from the rotary filer during cleaning by the air blower nozzle while the air having passed through the rotary filter is discharged outward through a silencer, the recovery bag being detachably attached a lower part of the case.

6. The dust collector according to claim 5, wherein the light dust or the like includes minute dust of food material or dust resulting from processing of plastic, paper or wood.
